(19) United States
(12) Patent Application Publication
(10) Pub. No.: US 2003/0115192 A1
(43) Pub. Date: Jun. 19, 2003

(54) One-step data mining with natural language specification and results

(76) Inventors: David Kil, Gilroy, CA (US); Kenneth Williams Fertig, Palo Alto, CA (US)

Correspondence Address: WELSH & KATZ, LTD, 120 S RIVERSIDE PLAZA, 22ND FLOOR, CHICAGO, IL, 60606, US

(21) Appl. No.: 10/087,240

(22) Filed: Mar. 1, 2002

Related U.S. Application Data
(62) Division of application No. 09/945,530, filed on Aug. 3, 2001.
(62) Division of application No. 09/942,435, filed on Aug. 29, 2001.
(60) Provisional application No. 60/274,008, filed on Mar. 7, 2001.

(51) Int. Cl. G06F 7/00; G06F 17/30

(52) U.S. Cl. 707/3

(57) ABSTRACT

A method and apparatus in various embodiments for controlling a data mining operation by specifying the goal of data mining in natural language, processing the data mining operation without any further input beyond the problem specification, and displaying key performance results of a data mining operation in natural language. One embodiment includes provides a user interface having a control for receiving natural language input describing the goal of the data mining operation from the control on the user interface. A second embodiment identifies key performance results, providing a user interface having a control for communicating information, and communicating a natural language description of the key performance results using the control on the user interface. In a third embodiment input data determining a data mining operation goal is the only input required by the data mining application.

This application claims the benefit of U.S. Provisional Application Ser. No. 60/274,008, filed Mar. 7, 2001, which is herewith incorporated herein by reference. This application is related to U.S. application Ser. No. 09/945,530, entitled “Automatic Mapping from Data to Preprocessing Algorithms” filed Aug. 30, 2001 (attorney docket number 7648/81349 00SC105, 111), which is herewith incorporated herein by this reference. This application is also related to U.S. application Ser. No. 09/942,435, entitled “Data Mining Application with Improved Data Mining Algorithm Selection” filed Nov. 16, 2001 (attorney docket number 7648/81348 00SC1069), which is herewith incorporated herein by this reference. This application is also related to co-pending application serial number Not Yet Assigned, entitled “Hierarchical Characterization of Fields from Multiple Tables with One-to-Many Relations for Comprehensive Data Mining,” filed the same day as this application, which is incorporated herein by reference. This application is also related to co-pending application serial number Not Yet Assigned, entitled “Data Mining Apparatus and Method with Graphic User Interface Based Ground-Truth Tool and User Algorithms,” filed the same day as this application, which is incorporated herein by reference.

### TECHNICAL FIELD

This invention relates generally to knowledge discovery in data. More specifically, one embodiment and mode of practicing this invention relates to a method and apparatus for controlling a data mining operation by specifying the goal of data mining in natural language. A second embodiment and mode of practicing this invention relates to processing the data mining operation without any further input beyond the problem specification in a method or apparatus that permits one-step data mining for novice users, thereby avoiding the difficulties associated with the interactive nature of data mining, such as the requirement to specify numerous parameters associated with various steps in data mining. A third embodiment and mode of practicing this invention relates to displaying key performance results of a data mining operation in natural language such as plain English so that a novice user can understand the results without having to consult an expert for interpretation.

### BACKGROUND ART

One of the more challenging steps for a novice user in running a data mining tool is specifying a problem. The user is required to learn how to use a complex user interface and understand a data model well enough to select the correct field as a dependent or target variable. The situation is even more difficult when the dependent or target variable is expressed as a mathematical operation combining several different fields. In such circumstances, it can be very difficult to specify the dependent variables.

Techniques are known for converting natural language queries into Boolean queries using a graphical user interface and text parser. Techniques are also known for performing a natural language translation of an SQL query. None of these techniques, however, address the important issue of mapping the goal of a data mining operation expressed in natural language in a form such as text into an actionable set of input and output specifications for data mining. Accordingly, there continues to exist a need for a more natural and intuitive approach to specifying the goal of a data mining problem.

In existing technology, performance results of a data mining operation are typically displayed in arcane scientific graphs, which can be confusing to a user who lacks scientific training and experience. Such scientific graphs and performance-log files are often difficult to understand. Sometimes, such scientific graphs and performance-log files can even obscure the information in which the user is principally interested. There exists a need, therefore, for an improved user interface method and apparatus for clearly communicating the results of a data mining operation.

Also in existing technology it can be difficult to keep track of all the data mining runs concurrently because no underlying record keeping engine tracks the performance results in a database. There exists a need, therefore, in data mining applications for a tool that can use a higher level of text-based and table-based abstraction so that a novice user can easily understand the results of a complex data mining operation while keeping all the performance results in a database for easy retrieval and performance comparison.

Data mining is typically considered an interactive process, requiring an expert to sift through a myriad of steps in order to obtain insights from data. The process typically begins with raw data after which the first step is problem specification. Following problem specification it is sometimes necessary to perform steps such as transformation, visualization, and cleaning to prepare the raw data. After these preparatory steps it is sometimes then necessary to specify data partitioning for training and testing. After data partitioning, algorithm and parameter specification is sometimes necessary. After the data mining operation has run, it may still be necessary to assess the results. In a typical data mining application using known techniques, each of these steps requires intervention from and interaction with an expert in data mining. There exists a need, therefore, for one-step data mining, including the ability to identify the current status of the data mining operation in response to a user inquiry.

The data mining software application described herein can operate in a general-purpose computer. A computer is generally a functional unit that can perform substantial computations, including numerous arithmetic operations and logic operations without human intervention. A computer can include a stand-alone unit or several interconnected units. In information processing, the term computer usually refers to a digital computer, which is a computer that is controlled by internally stored programs and that is capable of using common storage for all or part of a program and also for all or part of the data necessary for the execution of the programs; performing user-designated manipulation of digitally represented discrete data, including arithmetic operations and logic operations; and executing programs that modify themselves during their execution. A functional unit is considered an entity of hardware or software, or both, capable of accomplishing a specified purpose. Hardware includes all or part of the physical components of an information processing system, such as computers and peripheral devices.

A computer typically includes a processor, including at least an instruction control unit and an arithmetic and logic unit. The processor is generally a functional unit that interprets and executes instructions. An instruction control unit in a processor is generally the part that retrieves instructions in proper sequence, interprets each instruction, and applies the proper signals to the arithmetic and logic unit and other parts in accordance with this interpretation. The arithmetic and logic unit in a processor is generally the part that performs arithmetic operations and logic operations.

Information processing is generally the systematic performance of operations upon information. It includes data processing and can include operations such as data communication and office automation. Data processing is generally the systematic performance of operations upon data. Examples of data processing include arithmetic or logic operations upon data, merging or sorting of data, assembling or compiling of programs, or operations on text, such as editing, sorting, merging, storing, retrieving, displaying, or printing.

A program or computer program is generally a syntactic unit that conforms to the rules of a particular programming language and that is composed of declarations and statements or instructions needed to solve a certain function, task, or problem. A programming language is generally an artificial language for expressing programs. A computer system is generally one or more computers, peripheral equipment, and software that perform data processing. An end user in general includes a person, device, program, or computer system that utilizes a computer network for the purpose of data processing and information exchange.

Application software or an application program is, in general, software or a program that is specific to the solution of an application problem. An application problem is generally a problem submitted by an end user and requiring information processing for its solution. For a data mining software package or program such as described in the embodiments herein, the end user typically seeks to obtain useful information regarding relationships between the dependent variates or function and the source data.

Information is knowledge in any form concerning objects, such as facts, events, things, processes, or ideas, including concepts, that within a certain context has a particular meaning. Data is a reinterpretable representation of information in a formalized manner suitable for communication, interpretation, or processing.

A database is in general a collection of data organized according to a conceptual structure describing the characteristics of these data and the relationships among their corresponding entities, supporting application areas. It is a data structure for accepting, storing, and providing on demand data for multiple independent users. It typically includes a number of fields. These fields typically have names that often are suggestive of the field's contents. Often, the fields also have associated textual descriptions explaining what data is stored in the field. An object of data mining is to derive, discover, and extract from the database previously unknown information about relationships between and among these data and the relationships among their corresponding entities.

A natural language is a language whose rules are based on current usage without being specifically prescribed. Examples of natural language include, for example, English, Russian, or Chinese. In contrast, an artificial language is a language whose rules are explicitly established prior to its use. Examples of artificial languages include computer-programming languages such as C, Java, BASIC, FORTRAN, or COBOL.

### DISCLOSURE OF INVENTION

The invention, together with the advantages thereof, can be understood by reference to the following description in conjunction with the accompanying figures, which illustrate some embodiments of the invention.

One embodiment is a method for describing the goal of a data mining operation. The method of this embodiment includes but is not limited to providing a user interface having a control for receiving natural language input describing the goal of the data mining operation from the control on the user interface. The method can also include sending the natural language input to a text parser. The text parser can be available to identify keywords using, in one embodiment, Bayesian networks for lexical analysis to calculate maximum a posteriori probabilities for candidate target fields. The method can also include identifying keywords with the text parser; using Bayesian networks for lexical analysis of the natural language input with identified keywords; providing a database having fields containing data; selecting a field from the database as the target field, and using the results of the lexical analysis to calculate the maximum a posteriori probability that the target field is the dependent variable. Where the database fields have names, the method can also include comparing the target field name with the result of the lexical analysis. Where the database fields have descriptions, the method can also include comparing the target field description with the result of the lexical analysis. The method can also include identifying candidate fields that are relatively more likely to be the dependent variable than other fields in the database, displaying the candidate fields, and receiving selection input defining the dependent variable based on the candidate fields. The selection input can identify one candidate field as the dependent variable or specify a formula combining candidate fields to define the true independent variable. The user interface can reside on a client system and the text parser resides on a server system, or both can reside on the same system.

A second embodiment is a method in a computer system for communicating results of a data mining operation. The method includes but is not limited to identifying key performance results, providing a user interface having a control for communicating information, and communicating a natural language description of the key performance results using the control on the user interface. The method can also include providing a robust data model comprising each algorithm used, each algorithm's parameters, each algorithm's performance results, and input/output specification with time tag; and providing as part of the user interface text templates for communicating the key performance results. The method can also include providing (as part of the user interface) a plurality text templates for communicating the key performance results and selecting one text template from among the plurality of text templates for communicating the key performance results, whereby the user interface does not display the same text template for every data mining operation. The user interface can be provided on a client system and the data model on a server, or the user interface and the client system can both be contained on a general-purpose computer.

A third embodiment is a method in a computer system for controlling a data mining operation. This method includes a step of the computer system receiving problem specification input determining a data mining operation goal. The input data determining a data mining operation goal is the only input required by the data mining application. The problem specification input can be a formal definition based on a data model or can be natural language data. The method can also include identifying key performance results; providing a user interface having a control for communicating information; and communicating a natural language description of the key performance results using the control on the user interface.

A fourth embodiment is a data mining application user interface. The user interface includes, but is not limited to a control that receives natural language input describing the goal of a data mining operation and an interface that sends the natural language input to a text parser. The text parser can be available to look for keywords, to perform lexical analysis using, for example, Bayesian networks, and to calculate maximum a posteriori probabilities for candidate target fields by comparing the results of the lexical analysis with the table-space field names. The input data determining a data mining operation goal can be the only input required by the data mining application.

A fifth embodiment is a computer data signal stream for communicating the goal of a data mining operation. The data signal stream can include, but is not limited to, natural language input data describing the goal of the data mining operation, which is available for lexical analysis to identify at least one candidate data field. The data signal stream can further include problem specification data which specifies a goal of the data mining operation based on the at least one candidate data field identified by lexical analysis. Alternatively, the computer data signal stream for controlling a data mining operation can consist essentially of input data specifying the goal of the data mining operation, whereby no additional input is required to obtain useful results.

A sixth embodiment is an article of manufacture for a data mining application. The data mining application is available to perform a data mining operation on a database having fields. The data mining operation can be based on a dependent variable. The article of manufacture includes a computer readable medium, which in turn includes (but is not limited to) computer program code that provides for receiving natural language data describing the goal of a data mining operation; computer program code that provides for sending the natural language data to a text parser; computer program code that provides for performing a lexical analysis of the natural language data using a Bayesian network; computer program code that compares results of the lexical analysis to a database field to calculate a maximum a posteriori probability that the database field is the dependent variable; computer program code that outputs the identity of candidate database fields more likely than other database fields to be the dependent variable; and computer program code that provides for receiving problem specification data based on the candidate database fields. The computer readable medium can also contain, in the alternative or in addition, a plurality of natural language text templates for communicating the key performance results and computer program code that selects one text templates from among the plurality of text templates for communicating the key performance results, whereby the user interface does not display the same text template for every data mining operation. The computer readable medium can also contain, in the alternative or in addition, computer program code that provides for receiving input determining a data mining operation goal, wherein the input determining a data mining operation goal is the only input required by the data mining application.

### BRIEF DESCRIPTION OF DRAWINGS

Several aspects of the present invention are further described in connection with the accompanying drawings in which:

FIG. 1 is a block diagram illustrating mapping a goal of data mining in text to data fields for automated problem specification, text display of key data mining performance results, and one-step data mining with a “where-am-I” interrupt button.

FIG. 2 illustrates screens and windows that can be presented to the user in an embodiment for mapping a goal of data mining in text to data fields for automated problem specification, text display of key data mining performance results, and one-step data mining.

FIG. 3 is a data flowchart that illustrates an example of a path of data in solving the problem of mapping a goal of data mining in text to data fields for automated problem specification. FIG. 3 is a data flowchart that illustrates a path of data in solving the problem of mapping a goal of data mining in text to data fields for automated problem specification.

FIG. 4 is a program flowchart illustrating an example of a sequence of operations in mapping a goal of data mining in text to data fields for automated problem specification.

FIG. 5 is a system flowchart illustrating control of operations and data flow of one embodiment of a system for mapping a goal of data mining in text to data fields for automated problem specification.

FIG. 6 is a program network chart illustrating an example of a path of program activations and interactions to related data in a system for mapping a goal of data mining in text to data fields for automated problem specification.

FIG. 7 is a system resources chart illustrating an example of a configuration of data units and process units suitable for solving the problem of mapping a goal of data mining in text to data fields for automated problem specification.

FIG. 8 illustrates screens and windows that can be presented to the user in an embodiment for mapping a goal of data mining in text to data fields for automated problem specification.

FIG. 9 illustrates screens and windows that can be presented to the user in an embodiment mapping a goal of data mining in text to data fields for automated problem specification in an example with a thrombosis data set.

FIG. 10 illustrates an example using a thrombosis data set.

FIG. 11 is a data flow chart that illustrates an example of a path of data in solving the problem of text display of key data mining performance results.

FIG. 12 is a program flowchart illustrating a sequence of operations in an embodiment for text display of key data mining performance results.

FIG. 13 is a program network chart illustrating a path of program activations and interactions to related data in an embodiment of a system for text display of key data mining performance results.

FIG. 14 illustrates screens or windows in an embodiment for text display of key data mining performance results.

### MODES AND BEST MODE FOR CARRYING OUT THE INVENTION

In this application, the use of the disjunctive is intended to include the conjunctive. The use of definite or indefinite articles is not intended to indicate cardinality. In particular, a reference to “the” object or “a” object is intended to denote also one of a possible plurality of such objects.

While the present invention is susceptible of embodiment in various forms, there is shown in the drawings and described hereinbelow some exemplary and non-limiting embodiments, with the understanding that the present disclosure is to be considered an exemplification of the invention and is not intended to limit the invention to the specific embodiments illustrated.

In an embodiment, the user enters the goal of a data mining operation in a natural language such as plain English, in a form such as standard text. A text parser parses the goal specification in text. The text parser of the illustrated embodiment can identify key words, can perform lexical analysis with Bayesian networks, and can calculate the maximum a posteriori probabilities for candidate target fields by comparing the results of lexical analysis with table space field names and descriptions, if available.

Having parsed the text, the algorithm of this embodiment then recommends a set of fields, fewer than all the fields in the database, that have relatively higher probabilities to be candidates for or components of the dependent variable than other fields not recommended. The user can then narrow down the selection even further by selecting some of the suggested fields. If the dependent variable is actually some combination of the selected fields, the user can also define the true dependent variable by entering a mathematical expression.

For each target candidate, the embodiment ranks input features based on their level of contribution to the projected data mining performance. In one embodiment, the actual feature-ranking algorithm can be a hybrid of many algorithms. Examples of such algorithms are discussed in, for example, David Kil & F. Shin, Pattern Recognition and Prediction with Application to Signal Characteristics (New York: Springer-Verlag, 1996). Displaying feature-ranking results facilitates data mining problem formulation in terms of specifying inputs and outputs. For example, if some input features appear not to be relevant to the data mining problem specified, it is not be necessary to use all the features in the data analysis.

One embodiment prioritizes the results of a data mining operation, selects a vital set of information, and embeds that vital set of information into text boilerplates that can be customized. It is often seen that each specialized sector has or develops its own set of vocabulary. Examples of specialized market areas include finance, law, engineering design, manufacturing, medicine, biotechnology, and others. In contrast to this inconsistency in terminology, data mining works within the unifying framework of finding interesting relationships between inputs and outputs. Some customization is therefore useful so that the DM results are wrapped in sector-specific text templates. The boilerplate text template enables a novice user more easily to comprehend the results and derive actionable insights from them. The selection of relevant parameters from the entire set of available parameters and performance results in a database can be a function of the type of data mining operation and the type of specialized area in which the data mining operation is being performed. Types of data mining operations include, for example, classification, regression, prediction, association, and clustering. The boilerplate text template can be particularly adapted to each specialized market sector using the terminology ordinarily used by persons in that field.

In one embodiment the performance summary text descriptions are made to seem more human and less automatic by randomizing the templates that have been customized for each market sector. While different templates each provide essentially the same message, the body of the text can contain differently worded details text.

One embodiment provides one-step data mining. It asks the user to enter the goal of data mining, which can be specified in natural language such as plain English. This embodiment then employs techniques disclosed in provisional application No. 60/274,008, filed Mar. 7, 2001, which is incorporated herein by reference, in order to transport the user directly to analyzing output results. This embodiment selects all the algorithm parameters and runs the entire data mining operation automatically. After execution, the results can be displayed in natural language such as plain English, so that a user can interpret the results even without the benefit of a degree in statistics or expertise in data mining. In another embodiment, during the data mining operation the system can display the status of the operation. The user can interrupt the operation in order to view intermediate results to confirm that the process is working sensibly.

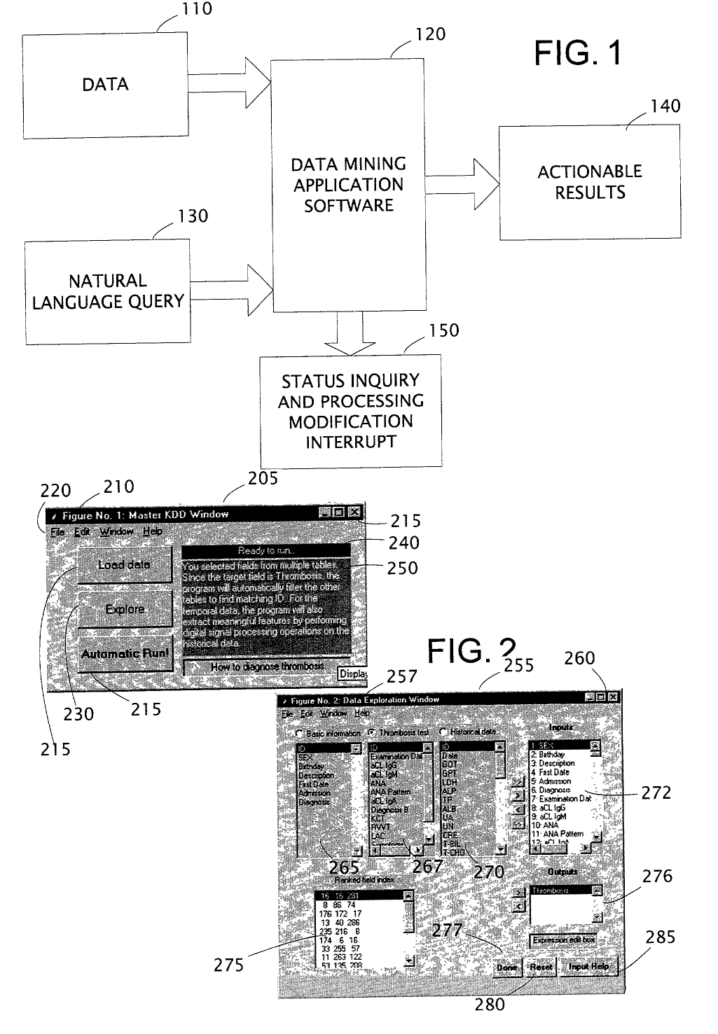

Referring now to FIG. 1, there is depicted a block diagram illustrating easy-to-use data mining. Data (110) is used by data mining application software (120). The data (110) can be, for example, a database containing many observations and other data. The data mining application software (120) can be used to uncover correlations and relations in this data (110). A natural language query (130) specifies in natural language the problem for the data mining application software (120) to solve. The data mining application software (120) then produces actionable results (140). Actionable results (140) can include information presented in natural language templates and/or hierarchical tables. During processing the data mining application (120), can be interrupted, generating a status inquiry and processing modification interrupt (150). This status inquiry and processing modification interrupt (150) can display information about the data mining application software, which information in one embodiment can be displayed in a window. For example, the status inquiry and processing modification interrupt (150) can display information about the data mining strategy and technique being used and why that strategy and technique were chosen. It can also permit a user to indicate a new, different, or altered strategy or technique.

Referring now to FIG. 2, there is illustrated a set of windows for interacting with a user of the data mining application software. A master KDD window (205) (where “KDD” refers to knowledge discovery in databases) for controlling this application for knowledge discovery in data, can be labeled with a suitable title bar (210) such as “Master KDD Window”. The master KDD window (205) can include, for example, conventional control elements (215) to minimize the window, maximize the window, restore the window, and/or close the window. The master KDD window (205) can further include a task bar (220) with convention elements such as drop down lists labeled “File,” “Edit,” “Window,” and “Help.” The master KDD window (205) can also include a load data control button (225), activation of which causes the data mining application software (120) to load the data set to be analyzed based on the interpretation of the user's entered goal of data mining in natural language. The master KDD window (205) can also include an explore button (230) labeled “Explore”. The master KDD window (205) can also include an automatic run button (235) labeled “Automatic Run!” or the like, activation of which causes the data mining application software to process automatically for a described goal. The master KDD window (205) can also include an indicator bar (240) to indicate the current status such as, for example, “Ready to run” or “Please specify goal.” [PDS1]The master KDD window (205) can also include a problem description field (250) indicating the general nature of the data mining problem being analyzed.

Still with reference to FIG. 2, there can be included a data exploration window (255), which is called when a user activates the explore button (230) of the master KDD window (205). The data exploration window (255) can include such conventional elements as a title bar (257) bearing a suitable title such as, for example, “Data Exploration Window”; conventional control elements (260) to minimize the exploration window, maximize the exploration window, restore the exploration window and/or close the exploration window; and a task bar (262) with drop down lists labeled, for example, “File,” “Edit,” “Window,” and “Help.” The file dropdown can include, for example, choices to save the results or close the window. The edit dropdown can include, for example, choices to copy information to a standard clipboard, cut information to a standard clipboard, or past information from a standard clipboard. The window dropdown can include choices, for example, duplicating some of the control elements or can permit the user to switch to a different window, or can permit the user to select optional display contents of the data exploration window. The help dropdown can include choices, for example, describing the operation of the data exploration window or providing information about the data mining application software (120).

The data-exploration window (255) can further include a basic information text box (265) containing fundamental information in the data set that is the subject of data mining. The data exploration window (255) can further include additional text boxes (267, 270) containing further information about the data set to be analyzed. The data exploration window (255) can further include an inputs text box (272) listing domain-space source variates relevant to the problem to be analyzed. The data exploration window (255) can further include a related field index textbox (275). The data exploration window (255) can further include an outputs textbox (276) listing the fields that are the range-space of potential candidate variables relevant to the problem to be analyzed. The data exploration window (255) can further include a done button (277) labeled, for example “Done” that when activated signals that the user has completed the data exploration window (255) and returns control to the master KDD window (205). The data exploration window (255) can further include a reset button (280) that can be labeled, for example “Reset” or “Clear” that returns the values of the various list boxes and text boxes of the data exploration window (255) to their initial conditions. In an embodiment, pressing the reset button (280) once can return the values of the list boxes and text boxes of the data exploration window (255) to the values they held when the data exploration window (255) was activated, and pressing the reset button (280) a second time can return the values of the list boxes and text boxes of the data exploration window (255) to a set of default values for the data set. The data exploration window (255) can further include an input-help button (285) labeled, for example, “Input Help” to describe to the user the operation of the data exploration window (255). Further, the input-help button can assist the user in selecting the relevant input variables that would have the most influential impact on predicting the output variable.

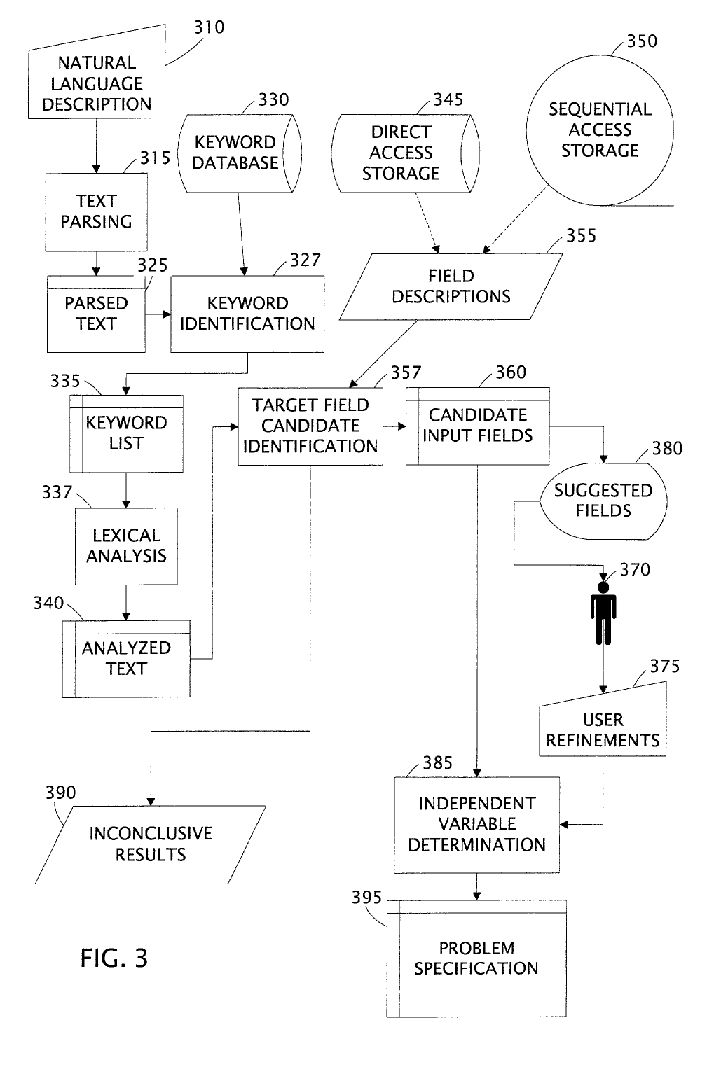

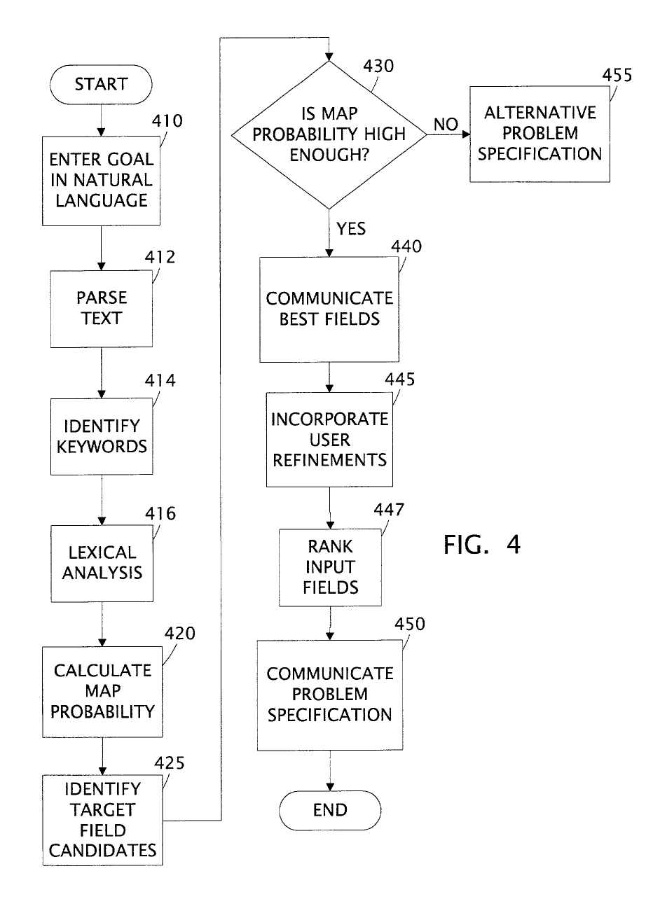

Referring now to FIG. 3, there is shown data flowchart that depicts a path of data in solving the problem of mapping a goal of data mining in text to data fields for automated problem specification. By way of overview, the activities associated with this flow of data may be summarized as follows. First, the user enters the goal of data analysis in natural language. A text-mining module then parses the text, identifies key words, and determines through lexical analysis what the user wants as an output variable. This determination of what the user wants as an output variable answers the question, “What does the user want to predict?” The matching process in the text-mining module can be greatly facilitated if there is a field-description database that explains each field in detail. Even if there is no such field-description database, however, the field name itself can be used in matching. If the text-mining module cannot find any sufficiently high-probability output candidate, it lists low-probability candidates and suggest that perhaps a better output choice can be determined as a combination of multiple fields. It is up to the user to either select one of the low-probability candidates or derive a new target or output field by combining multiple relevant fields.

Referring still to FIG. 3, a natural language description (310) of a goal of data mining is entered by a user as text in a natural language. Which particular natural language is used is a detail of implementation not specifically prescribed herein. The input can contain full sentences or sentence fragments and clauses that describe the goal of the data mining operation to be performed. This input can therefore take the form of a stream or string of text. Text is, in general, data in the form of characters, symbols, words, phrases, paragraphs, sentences, tables, or other character arrangements, intended to convey a meaning, and whose interpretation is essentially based upon the reader's knowledge of some natural language or artificial language. A character is, in general, a member of a set of elements that is used for the representation, organization, or control of data. A control character is, in general, a character whose occurrence in a particular context specifies a control function. A graphic character is, in general, a character (other than a control character) that has a visual representation and is normally produced by writing, printing or displaying. A letter is, in general, a graphic character that, when appearing alone or combined with others, is primarily used to represent a sound element of a spoken language. An ideogram or ideographic character is, in general, in a natural language, a graphic character that represents an object or a concept and associated sound elements. Examples of ideographic characters include a Chinese ideogram or a Japanese Kanji.

In the embodiment depicted in FIG. 3 the natural language description (310) is data, the medium being of any type where the information is entered manually at the time of processing. Examples of such media include on-line keyboards, switch settings, push buttons, light pens, styli, and bar-code wand. Alternatively, in other embodiments not pictured, the natural language description (310) could be embodied in any convenient medium including, for example, punched cards, magnetic cards, mark sense cards, stub cards, mark scan cards, paper tape, direct access storage, magnetic disk, drum, flexible disk, magnetic tape, tape cartridge, tape cassette, or any other convenient medium.

The natural language description (310) is operated on by a text-parsing module (315) to produce data in the form of parsed text data (325). The parsed text data (325) is data in which, for example, distinct words composed of letters or ideograms make up data elements that are units of data that, in this context, are considered indivisible. These word data elements can be ordered by arranging them according to specified rules. In one embodiment, for example, it can be advantageous to arrange these word data elements according to the order in which they were entered. In another embodiment it can be advantageous, for example, to arrange these data elements in alphabetical sequence. The distinct words as data elements can be stored in any convenient data structure such as, for example, a list. This parsed text data (325) can typically be stored in any of several data objects known to those of ordinary skill in the art. In the embodiment shown in FIG. 3 the medium for the parsed text (325) is depicted as internal storage.

Referring still to FIG. 3, the parsed text data (325) is used by a keyword-identification module (327), which identifies keywords that can be stored in a keyword database (330) provided before data mining begins. In another embodiment not pictured, the keyword database can be updated based on the selected dependent variable in light of the parsed text data (325). Keywords can be identified by comparing the parsed text data (325) to the keyword database (330) using any technique appropriate for such comparison. For example, one embodiment of the application software can search the keyword database (330) for each word in a list of parsed text data (325). The search can use fuzzy logic or the like.

The keyword-identification module (327) produces keyword list data (335) that is passed to a lexical analysis module (337). In one embodiment this lexical analysis module (337) can use a Bayesian network. In another embodiment this lexical analysis module (337) can use some other link analysis technique. The lexical analysis module (337) produces analyzed text (340) as output.

Analyzed text (340) is passed to a target-field-candidate-identification module (357). If the target-field-candidate-identification module (357) does not produce a result showing a high enough match probability, the application software can signal inconclusive results (390). The target-field-candidate-identification module (357) transforms analyzed text (340) into candidate input fields data (360). The target-field-candidate identification-module (357) uses a field description database (355). In the absence of the field description database, the module can rely on the actual field names. The field description database is data that can be stored in any convenient form. Examples of acceptable storage formats include, but are not limited to, Microsoft Excel and Access files. The data in the field description database (355) can be derived from the database that is the subject of the data mining operation. This database can be stored, in one embodiment in direct access storage (345) as data directly accessible, the medium being, for example, magnetic disk, drum, or flexible disk. This database can alternatively or also be stored in sequential access storage (350) as data that is only sequentially accessible, the medium being, for example, magnetic tape, tape cartridge, tape cassette.

The application software can then display suggested fields (380) to the user (370). If the text-mining module cannot find any sufficiently high-probability output candidate, it lists low-probability candidates and suggest that perhaps a better output choice can be determined as a combination of multiple fields. The user refinements (375) to the suggested fields (380) can include confirmation of recommendation using visual tools and further modification of the candidate-input list based on intuition or field knowledge. The user refinements (375) to the narrowed set of fields are depicted as data, the medium being of any type where the information is entered manually at the time of processing. If the actual dependent variable is not expressly and literally contained in the database, the user can enter a function combining one or more fields in the database. As one trivial example of such a function, if the actual dependent variable is an observed value in the database the user can select that variable (which is equivalent to multiplying that variable by the one and all other suggested variables by zero).

An independent-variable-determination module (385) receives as input user refinements data (375) and candidate input fields data (360) to produce a problem specification (395). It is up to the user to either select one of the low-probability candidates or derive a new target or output field by combining multiple relevant fields. The problem specification (395) identifies a selected dependent variable. As described above, this selected dependent variable can be one of the fields suggested by the program or can be a more complicated value calculated as a function of one or more separate fields. The application software then passes this selected or defined dependent variable on to the rest of the data mining operation.

As an example, a retail firm may desire to predict customer value, but that term may not exist under that name or description in the database. The analyst can create a new field called customer value and define it as the total amount spent on high-priced items. Once the user determines an output choice (whether by agreeing with the recommended output or defining a new output), an Input-Help module can be invoked to find the most relevant input candidates for predicting the selected output. Having thus defined the problem, the core of data mining can commence.

Referring now to FIG. 4, there is depicted a program flowchart illustrating the sequence of operations in an embodiment for translating a goal of data mining expressed in text into the specification of input and output variables automatically prior to the commencement of data mining. Upon starting, the embodiment first solicits the user to enter the goals in natural language. The enter-goal-in-natural-language process (410) is a processing function to retrieve input text. In one embodiment, the enter-goal-in-natural-language process (410) uses a simple input query. Alternatively, in a second embodiment, the enter-goal-in-natural-language process (410) uses a window object with a text box for retrieving text input. A window (or display window) is, in general, a part of a display image with defined boundaries, in which data is displayed. A display image is, in general, a collection of display elements that are represented together at any one time on a display surface. A display element is, in general, a basic graphic element that can be used to construct a display image. Examples of such a display element include a dot or a line segment.

In some embodiments the enter-goal-in-natural-language process (410) can include at least some facility for text processing or text editing. Text processing (or word processing) comprises data processing operations on text, such as entering, editing, sorting, merging, retrieving, storing displaying, or printing. Data processing (or automatic data processing) is the systematic performance of operations upon data. In general, examples of data processing include arithmetic or logic operations upon data, merging or sorting of data, assembling or compiling of programs, or operations on text, such as editing, sorting, merging, storing, retrieving, displaying, or printing. Text editing includes using a text processor to manipulate text, such as to rearrange or change text, including additions and deletions or reformatting.

After the enter-goal-in-natural-language process (410), the control passes to a parse-text process (410). The parse-text process (412) is a processing function to separate words from other characters, such as white space and punctuation. Any algorithm suitable to parse text into words indicated by letters or ideographs can be used. Those of ordinary skill in the art will recognize in general the equivalence of such algorithms for text parsing as are now known or may later be developed.

After the parse-text process (412), the control passes next passes to an identify-keywords process (414). The identify-keywords process (414) is a processing function that uses a keyword database. The identify-keywords process (414) matches words parsed from the text by the parse-text process (412) with known keywords. This matching can be performed by any algorithm suitable for this purpose. Those of ordinary skill in the art will recognize in general the equivalence of such algorithms for keyword identification as are now known or may later be developed.

After the identify-keywords process (414), the control passes next to a lexical analysis process (416). The lexical analysis process (416) is a processing function to extract information from the text input for comparison to descriptions of fields in the database to be analyzed in the data mining operation. In one embodiment, the lexical analysis process (416) can use Bayesian networks. In another embodiment, the lexical analysis process (416) can use other link-analysis techniques. Those of ordinary skill in the art will recognize in general the equivalence of these and other algorithms for lexical analysis as are now known or may later be developed.

The next step concerns calculation of maximum a posteriori (“MAP”) probabilities. After the lexical analysis process (416), control passes next to a calculate-MAP-probability process (420). The calculate-MAP-probability process (420) is a processing function to compare the results of the lexical analysis process (416) with names and descriptions of fields in the database to be analyzed by data mining software package.

After the MAP probability calculate-MAP-probability process (420), control passes next to an identify-target-field-candidates process (425). The identify-target-field-candidates process (425) is a processing function to identify likely dependent variable fields in the database to be analyzed by the data mining software package. Based on the results of the comparison performed in the calculate-MAP-probability process (420), the identify-target-field-candidates process (425) can select those fields most likely to represent dependent variables for the end user's problem definition.

After the calculate-MAP-probability process (420) and the identify-target-field candidates process (425), the application software evaluates the condition “Is MAP probability high enough” in a decision operation (430). For some natural language problem descriptions, the application software might be unable to identify fields that are more likely to match the problem definition than other fields. In that circumstance, instead of suggesting comparatively less unsuitable fields, the application software can in one embodiment call an alternative problem specification process (453).

If the result of the decision operation (430) is that the MAP probability is high enough, control passes to a communicate-best-fields process (440). The communicate-best-fields process (440) is a processing function to communicate to the end user the identification and ranking of fields likely to be relevant to the dependent variable that the application software identifies based on the enter-goal-in-natural-language process (410). This communicate-best-fields process (440) thus enables the end user to complete the selection and definition of the dependent variable for the data mining problem.

After the communicate-best-fields process (440) control passes next to an incorporate-user-refinements process (445). The incorporate-user-refinements process (445) is a processing function to receive from the end user a final determination of the dependent variable in the data mining problem. The end user can make this determination based on the information communicated in the communicate-best-fields process (440). If the dependent variable is a field displayed in the communicate-best-fields process (440), the end user can simply select that field. This is the equivalent to a trivial function over the set of displayed fields, i.e., the cross product of the subset of field-space displayed in the communicate-best-fields process (440) with an orthogonal unit vector of the field selected. In the alternative, if the actual dependent variable is some combination of fields in the database, the end user can specify the actual function combining fields that comprise the actual dependent variable.

After the incorporate-user-refinements process (445), control passes next to a rank-input-fields process (447). The rank-input-fields process (447) is a processing function to rank input features based on their level of contribution to the projected data mining performance. One way to assess this contribution is to measure the input field's accurate prediction of the selected output variable. Many actual feature-ranking algorithms can be used. The interchangeability and general equivalence of these algorithms will be appreciated by those of ordinary skill in the art. The selection of a particular feature-ranking algorithm for a particular embodiment of the data mining application software package might depend on various factors and is within the abilities of those of ordinary skill in the art. In one embodiment of the data mining application software package, the end user can be given the option to select input features. In a second embodiment of the data mining application software package, the selection of input features can be performed entirely by the data mining application software package. Any algorithm suitable for sorting can be employed for this rank-input-fields process (435).

After the rank-input-fields process (447), control passes next to a communicate-problem-definition process (450). By this point, the goal of the data mining has been formally defined in terms of a dependent variable and of input features. The communicate-problem-definition process (450) is a processing function that communicates this definition of a data mining problem to other part of the data mining application software package for analysis and solution.

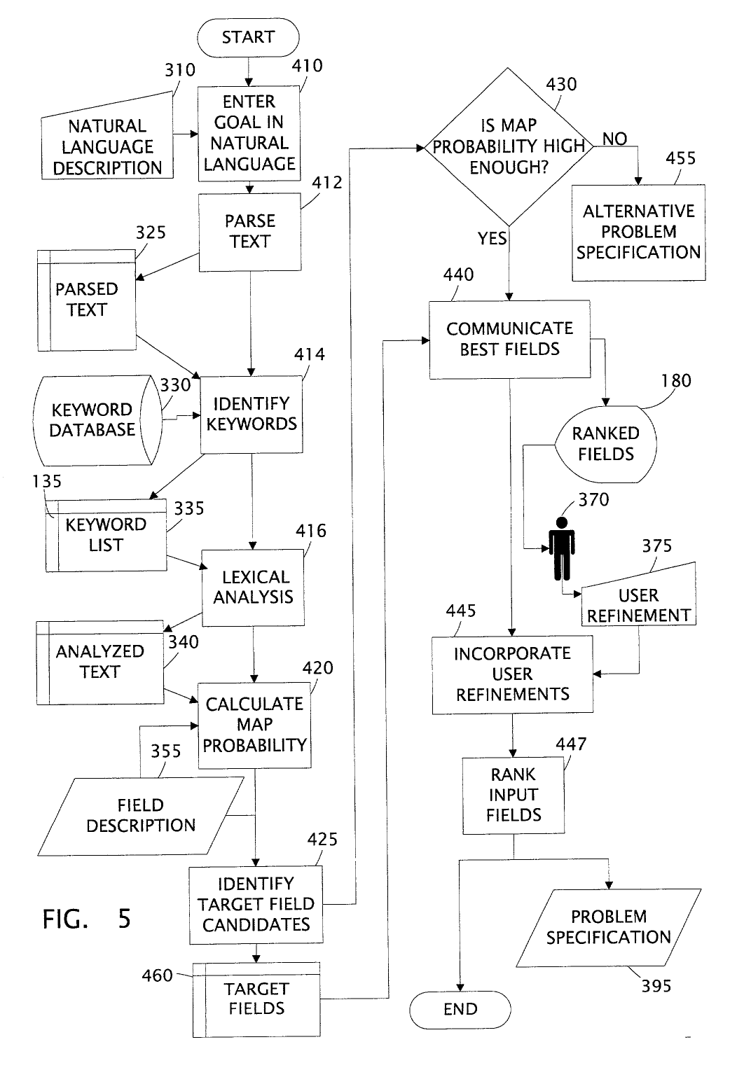

Referring now to FIG. 5, there is depicted a system resources chart illustrating a configuration of data units and process units suitable for use in a software application to solve the problem of translating a goal of data mining expressed in text into the specification of input and output variables automatically prior to the commencement of data mining. The control passes first to an enter-goal-in-natural-language process (410), which is a processing function to receive as input natural language description data (310) describing the goal of the data mining operation in natural language. It is anticipated that the natural language description data (310) can be input manually at run time, but this is a detail of the implementation that can vary in other embodiments. Other forms of natural language description data in other media can be used without altering the basic characteristics of the invention.

The control passes next to a parse-text process (412), which produces parsed text data (325). The parsed text data (325) can be put in internal storage, but those of ordinary skill in the art will recognize this as a detail of implementation that can be changed without altering the invention. The parsed text data (325) is then used in conjunction with a keyword database (330) in an identify-keywords process (414). The identify-keywords process (414) matches words in the parsed text data (325) produced by the parse-text process (412) with words in the keyword database (330).

Still with reference to FIG. 5, after the identify-keywords process (414) a lexical analysis process (416). In one embodiment, the lexical analysis process (416) can use Bayesian networks. In another embodiment, the lexical analysis process (416) can use other link-analysis techniques. The lexical analysis process (416) produces analyzed text data (340), here depicted as being stored in interned storage although the media for such analyzed text data (340) is a detail of implementation that can be varied in different embodiments of the invention. This analyzed text data (340) and a field description database (355) are next used in a calculate-MAP-probability process (420).

After the MAP probability process (420), control passes to an identify-target-field-candidates process (425). The identity-target-field-candidates-process (425) is a processing function that uses the field descriptions database (355) and the results of the calculate-MAP-probability process (420) to select target fields data. The software application next evaluates the condition “Is MAP probability high enough” in a decision operation (430). If that conditional evaluates False, then in one embodiment control is passed to an alternative-problem-specification-process (455).

Alternatively, if that conditional evaluates True, the software application next performs a communicate-best-fields process (440). The communicate-best-fields process (440) is a processing function that communicates ranked fields data (380) to the user (370). This communication can be by a display device such as cathode ray tube, although other forms of communication are within the scope of this invention.

After the communicate-best-fields-process (440), control next passes to a incorporate-user-refinements process (445). The incorporate-user-refinements process (445) is a processing function that uses user refinement data (375) received from the user (370), whether manually or by any other means. If the dependent variable is among a ranked field data (380) in the communicate-best-field process (440), the user (370) can simply select that field. In the alternative, if the actual dependent variable is some combination of fields in the database, the user (370) can specify the actual function combining fields that comprise the actual dependent variable. After the incorporate-user-refinements process (445), control pauses to a rank-input-fields process (447). The rank-input-fields process (447) is a processing function that ranks input features based on their level of contribution to the projected data mining performance. The application then passes problem specification data (395) to other components of the data mining software application for analysis and solution.

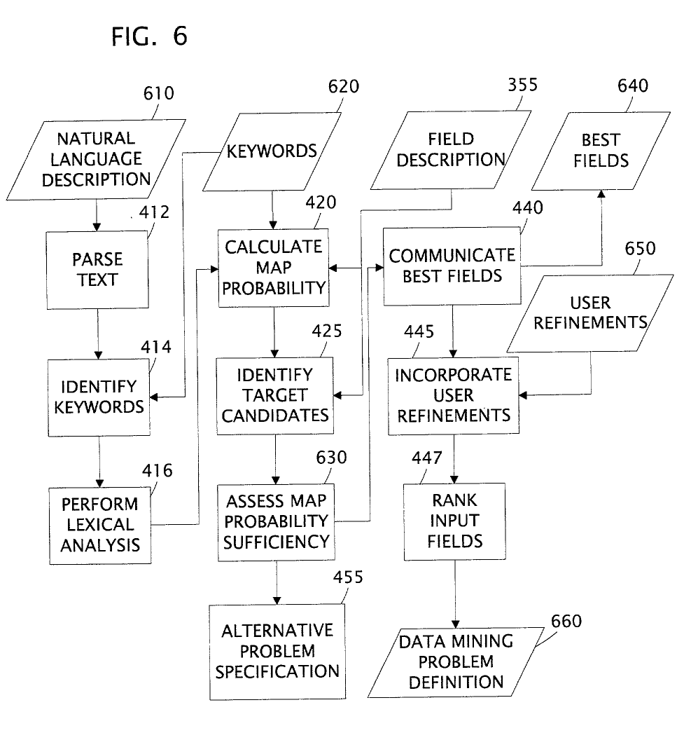

Referring now to FIG. 6, there is depicted a program network chart illustrating the path of program activations and the interactions to related data for translating a goal of data mining expressed in natural language text into the specification of input and output variables automatically prior to the commencement of data mining. Natural language description data (610) describing the data mining problem to be solved passes to a parse-text process (412). The parse text-process (412) upon completion activates a identify-keywords-process (414), which interacts with keywords data (620). The identify-keywords process (414) upon completion activates a lexical analysis process (416). The lexical analysis process (416) upon completion activates to calculate-MAP-probability process (420), which also interacts with the keywords data (620) and field descriptions data (355). The calculate-MAP-probability process (420) upon completion activates an identify-target-candidates process (425), which also interacts with the field descriptions data (355). The identify-target-candidates process (425) upon completion activates an assess-MAP-probability-sufficiency process (630). The assess-MAP-probability-sufficiency process (630) can act to transfer control to an alternative-problem-specification process (455). In the alternative, upon completion the assess-MAP-probability-sufficiency process (630) control can pass to a communicate-best-fields process (440), which communicates best fields data (640) to the end user. The communicate-best-fields-process (440) upon completion activates user refinement process (443), which interacts with user refinements data (650). Control then passes to a rank-input-fields process (447). Upon completion of the rank-input-fields process (353), the program produces data mining problem definition data (660) available to be passed to a data mining application.

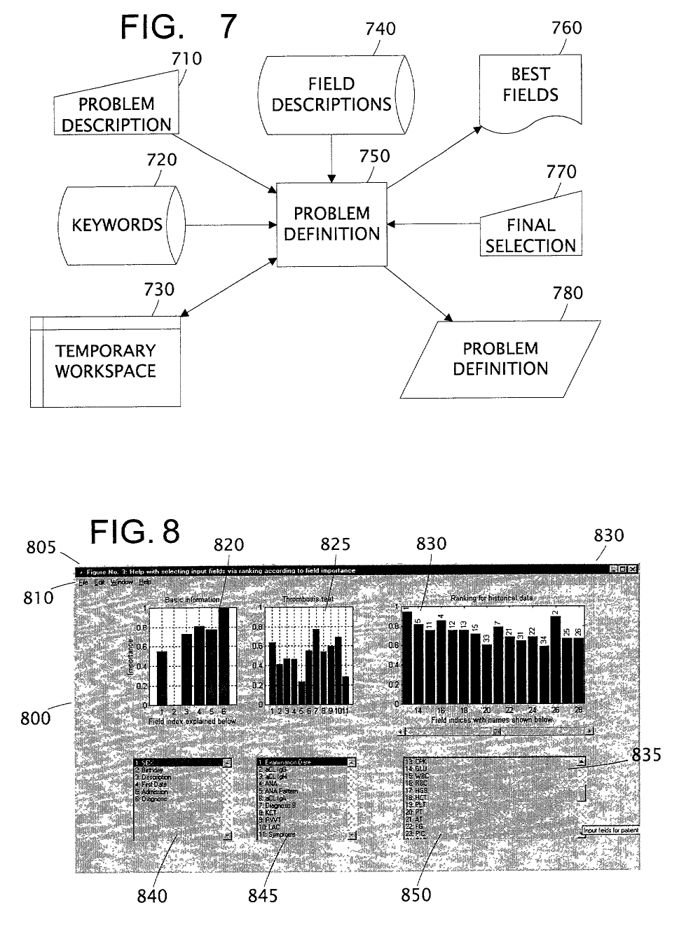

Referring now to FIG. 7, there is depicted a system resources chart illustrating a configuration of data units and process units suitable for translating a goal of data mining expressed in natural language text into the specification of input and output variables automatically prior to the commencement of data mining. System resources interact through a problem definition processor (750), which is a processing unit that can be implemented, for example, in a general-purpose digital computer or computer system.

Problem description data (710) is a natural language description of the goal to be analyzed by the data mining software application. As depicted, in one embodiment the medium of problem description data (710) can be manual input. Manual input is data, the medium being of any type where the information is entered manually at the time of processing, for example, on-line keyboard, switch settings, push buttons, light pen, bar-code wand. Alternatively, in other embodiments, the natural language description of the problem description data (710) could have been provided previously and stored in some other medium. Problem description data (710) communicates with the problem definition processor (750).

Problem definition data (780) specifies the goal of a data mining problem in an artificial language to be communicated to a data mining software application. Problem definition data (780) includes definitions of the dependent variables and the features to be analyzed by a data mining software application. The problem definition data (780) can be in any form. The medium of the problem definition data (780) as depicted is unspecified.

Keywords data (720) is a database or other suitable data structure containing keywords to look for in problem description data (710) that suggest correlations to field descriptions data (740). The keywords data (720) is here depicted as direct access storage. Direct access storage is data directly accessible, the medium being, for example, magnetic disk, drum, or flexible disk. Other media and storage forms are possible and equivalent for purposes of this invention to direct access storage, including but not limited to sequential storage and internal storage.

Temporary workspace data (730) is storage used for working results, such as text that has been parsed and lists of fields likely to be part of the problem definition data (720). Temporary workspace data is here depicted as internal storage. Internal storage is data stored in, for example, RAM or a cache. Temporary workspace data (730) interacts with the problem definition processor (750).

Field descriptions data (740) is a database or other suitable data structure containing field names and descriptive information regarding the database that can be analyzed by the data mining software application. Field descriptions data (740) is here depicted as direct access storage. Other media and storage forms are possible and equivalent for purposes of this invention to direct access storage, including but not limited to sequential storage and internal storage.

Best fields data (760) is data communicated to the end user containing suggestions and guidance about problem definition data (780). As here depicted, in one embodiment where the end user is a person, best fields data (760) can be human readable data, the medium being, for example, printed output, microfilm, tally roll, data entry forms. In another embodiment where the end user is another computer or computer system, best fields data (760) can be in a medium readable by that end user but not by a person. Best fields data (760) is generated by the problem definition processor (750).

Final selection data (770) is data from the end user that specifies the problem definition data (780) in light of the best fields data (760) communicated to the end user. As depicted, in one embodiment the medium of final selection data (770) can be manual input. In a second embodiment such as, for example, where the end user is a computer system instead of a person, the final selection data (770) can be in a medium other than manual input. In a third possible embodiment, there is no final selection data (720) at all, the problem definition data (780) being generated entirely by the problem definition processor (750) based on the problem description data (710) and other resources.

Referring now to FIG. 8, there is illustrated an example using a thrombosis data set. In general, the data set comprises three depicted tables: basic patient information, thrombosis-test results, and medical history. In this example, the field named “thrombosis” is the actual target variable. The goal of the data mining operation is to identify other input fields relevant in diagnosing thrombosis. Within this example, the “birthday” field in particular shows an example of a field having no predictive power.

The example is illustrated by a display window (800) containing elements used in one embodiment implementing the process. The display window (800) in this example includes conventional elements such as title bar (805), a drop-down task menu (810) and control elements (815). The title bar (805) can contain any appropriate title such as, for example, “Figure No. 3: Help with selecting input be a ranking according to field importance.” The drop-down task menu (810) can contain conventional elements such as a file menu, an edit menu, and window menu, and a help menu. The control elements (815) can include conventional controls such as a button to minimize the window (800), a button to maximize the window (800), a button to restore the window (800), and a button to close the window (800).

The window (800) in this example depicts data from three tables: a basic information table (820), a thrombosis test table (825), and a ranking for historical data table (830). If a table is too large to be displayed within the allocated portion of the window (800), additional display control elements such as, for example, a slider control bar (835), can be included to permit subsections of the window (800) to be scrolled to display all data. In this example, fields from each table are explained in text boxes below that table. Thus, the fields from the basic information table (820) are enumerated in the basic information text box (840), which identifies the fields as sex, birthday, description, first date, admission, and diagnosis respectively. The fields charted in the thrombosis test table (825) are enumerated in the thrombosis test list box (845). The fields charted in the ranking for historical data table (830) are enumerated in the ranking for historical data list box (850). List boxes (840, 845, 850) can typically include a slider control bar to scroll through the items listed.

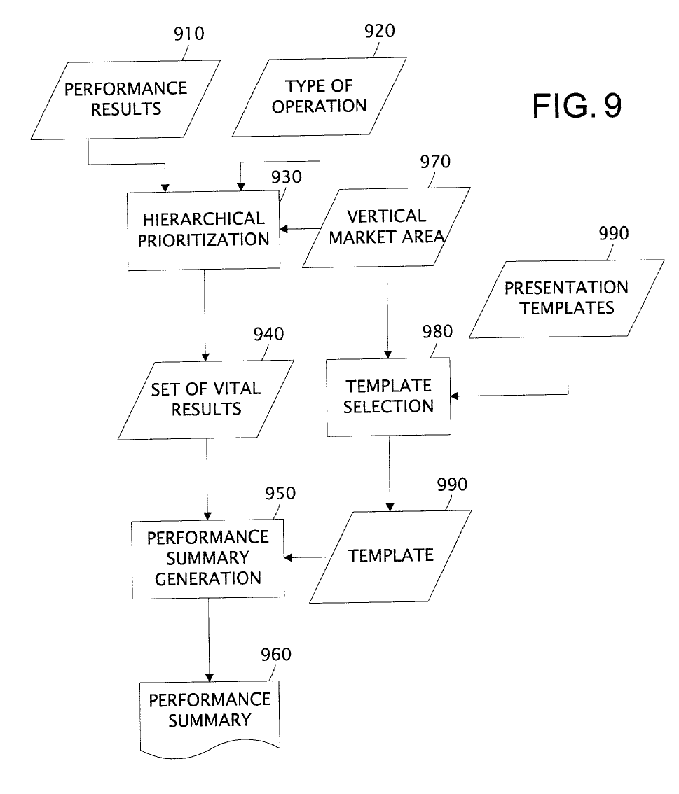

Referring now to FIG. 9, there is depicted a data flow chart illustrating a path of data and the processing steps in an embodiment of a method for displaying key performance results of data mining operation in natural language such as plain English to that a novice user can understand the results without having to consult an expert for interpretation. The operation takes as input performance results of data (910) and type of operation data (920). These input performance results of data (910) and type of operation data (920) serve as input for a hierarchical prioritization process (930). This data is part of a robust data model comprising each algorithm used, each algorithm's parameters, each algorithm's performance results, and input/output specification with time tag. Input/output specification with time tag can be understood as follows. If the user performs multiple runs using different combinations of inputs and outputs over time, the performance database can keep track of all the histories (including input, output, and performance) so that the user or new users can keep abreast of what DM operations have been performed on a particular data set. This tracking can help to reduce or eliminate of redundancy and improve productivity. A third source of information is presentation templates data (990). Presentation templates data (990) is used by a template-selection process (980). The template selection-process (980) and the hierarchical-prioritization-process (930) both also can take as input information from vertical market area data (970). The hierarchical-prioritization-process (930) generates as its output a set of vital results data (940). The set of vital results data (940) passes as input to a performance-summary-generation process (950). The template selection process (980), using vertical market area data (970) as input, generates output template data (990). The template data (990) is also provided as input to the performance summary generation process (950). The performance summary generation process (950) generates as output performance summary data (960), which can then communicated to the user by any convenient means such as, for example, display on a cathode ray tube, output to a printer, or other output methods.

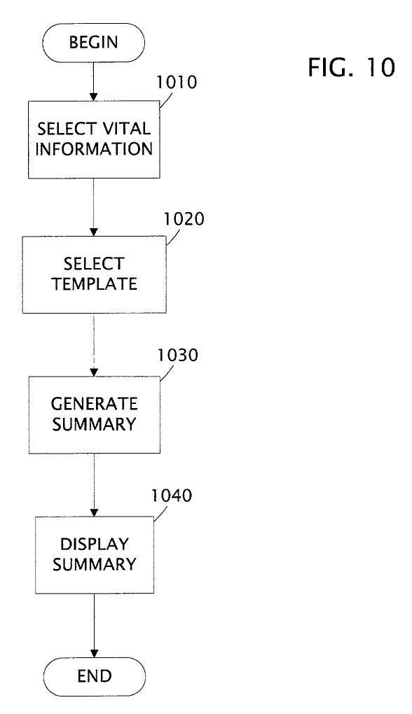

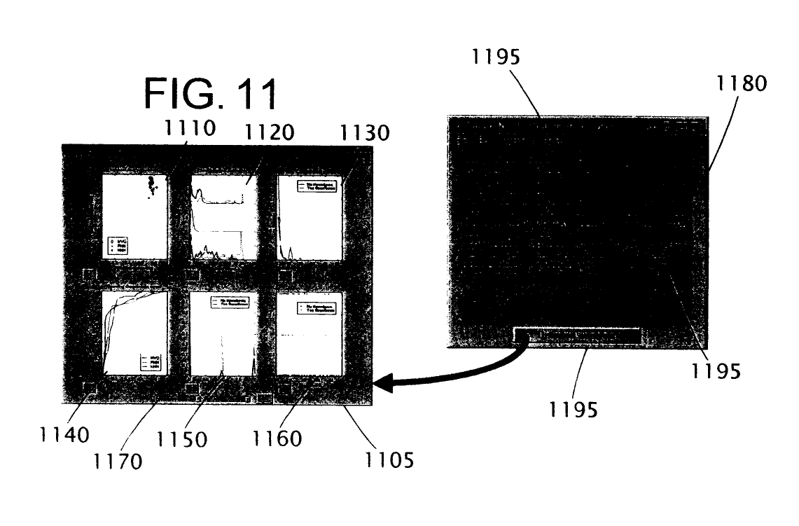

Referring now to FIG. 10, there is shown a program flow chart illustrating the sequence of operations in a program to display key performance results of data mining operation in natural language. In this illustrated embodiment, control passes first to a select-vital-information process (1010). The select-vital-information process (1010) identifies key performance data about which information can be communicated to the user. Control passes next to a select-template process (1020). The select-template process (1020) identifies a predefined template appropriate for displaying the key information identified in the select-vital-information process (1010). After the select-template process (1020) control passes next to a generate-summary process (1030). The generate-summary process (1030) can create a summary using the template identified in the select-template process (1020) to communicate the information identified in the select-vital-information process (1010). After the generate-summary process (1030) control passes next to a display-summary process (1040), which communicates the template containing the vital information to the user by any convenient means such as, for example, output to a video display or to a printer.

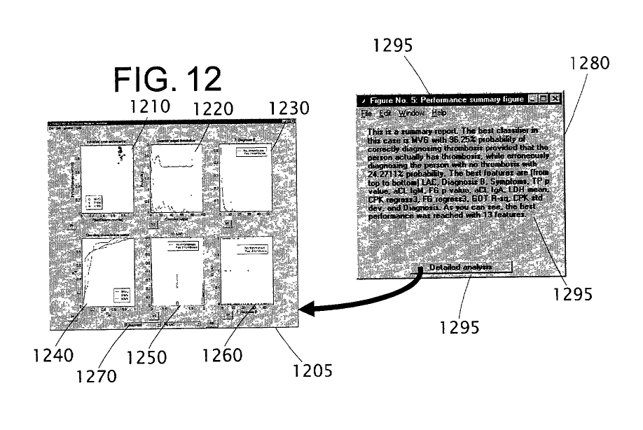

Referring FIG. 12, there are depicted two windows illustrating one example of an embodiment performing the display of key performance results of a data mining operation in natural language. In this embodiment, a performance window (1280) displays first. The performance window (1280) can include conventional elements (1295) such as a title bar, control elements, and drop-down task menus. In the depicted example, the title bar in the conventional control elements (1295) of the performance summary window (1280) contains the title “performance summary figure.” The performance summary window (1280) can also include a text box (1285), which displays key data mining performance results using a text template in a natural language such as, for example, English. The performance summary window (1280) can also include a detailed analysis button (1290). Activating the detailed analysis button (1290) can cause the display of a performance detail window (1205). The performance detail window (1205) can include detailed charts (1210, 1220, 1230, 1240, 1250, 1260), which show in more detail and in graphic form the information summarized in the summary window (1280). Additional controls (1270) can be included in the detail window (1205), the additional controls (1270) providing access to additional information.

While the present invention has been described in the context of particular exemplary data structures, processes, and systems, those of ordinary skill in the art will appreciate that the processes of the present invention are capable of being distributed in the form of a computer readable medium of instructions and a variety of forms and that the present invention applies equally regardless of the particular type of signal bearing computer readable media actually used to carry out the distribution. Computer readable media includes any recording medium in which computer code may be fixed, including but not limited to CD's, DVD's, semiconductor ram, rom, or flash memory, paper tape, punch cards, and any optical, magnetic, or semiconductor recording medium or the like. Examples of computer readable media include recordable-type media such as floppy disc, a hard disk drive, a RAM, and CD-ROMs, DVD-ROMs, an online internet web site, tape storage, and compact flash storage, and transmission-type media such as digital and analog communications links, and any other volatile or non-volatile mass storage system readable by the computer. The computer readable medium includes cooperating or interconnected computer readable media, which exist exclusively on single computer system or are distributed among multiple interconnected computer systems that may be local or remote. Those skilled in the art will also recognize many other configurations of these and similar components which can also comprise computer system, which are considered equivalent and are intended to be encompassed within the scope of the claims herein.

Although embodiments have been shown and described, it is to be understood that various modifications and substitutions, as well as rearrangements of parts and components, can be made by those skilled in the art, without departing from the normal spirit and scope of this invention. Having thus described the invention in detail by way of reference to preferred embodiments thereof, it will be apparent that other modifications and variations are possible without departing from the scope of the invention defined in the appended claims. Therefore, the spirit and scope of the appended claims should not be limited to the description of the embodiments contained herein. The appended claims are contemplated to cover the present invention any and all modifications, variations, or equivalents that fall within the true spirit and scope of the basic underlying principles disclosed and claimed herein.

### INDUSTRIAL APPLICABILITY

In some embodiments, the data mining application software is easy to use with most functionality behind the scenes. Such embodiments can include preprocessing, intelligent performance optimization, information visualization, or an intuitive graphical interface (GUI) that provides guidance for novice users. Such embodiments can provide a near turnkey solution to expand the use of data mining technologies.

In some embodiments, the data mining application software provides technically powerful data mining capabilities. Such embodiments can include a robust algorithm set or scalability for large data sets. Some embodiments can provide digital signal processing and image processing algorithms for temporally and spatially sampled data, such as macroeconomic data or images. Some embodiments can provide fusion of several complementary algorithms. Some embodiments can provide advanced or simple visualization tools to enhance the interpretation of data mining results in order to derive actionable insights.

In some embodiments, the data mining application software is flexible and customizable. Some embodiments can provide seamless insertion of user's algorithms through file-based I/O and dynamic script generation that maps user's requests into actions. Some embodiments can provide web-based data mining through intranet and or Internet.

In one embodiment the particular processes described above may be made, used, sold, and otherwise practiced as articles of manufacture as one or more modules, each of which is a computer program in source code or object code and embodied in a computer readable medium. Such a medium may be, for example, floppy disks or CD-ROMS. Such an article of manufacture may also be formed by installing software on a general purpose computer, whether installed from removable media such as a floppy disk or by means of a communication channel such as a network connection or by any other means.

I claim:

1. A method for describing the goal of a data mining operation, the method comprising
providing a user interface having a control for receiving natural language input;
receiving natural language input describing the goal of the data mining operation from the control on the user interface.

2. The method for describing the goal of a data mining operation having a dependent variable according to claim 1, further comprising:
sending the natural language input to a text parser.

3. The method for describing the goal of a data mining operation having a dependent variable according to claim 2, wherein the text parser is available to identify keywords, the text parser is available to use Bayesian networks for lexical analysis to calculate maximum a posteriori probabilities for candidate target fields.

4. The method for describing the goal of a data mining operation having a dependent variable according to claim 2 further comprising:
identifying keywords with the text parser;
using Bayesian networks for lexical analysis of the natural language input with identified keywords;
providing a database having fields containing data;
selecting a field from the database as the target field, using the results of the lexical analysis to calculate a maximum a posteriori probability that the target field is the dependent variable.

5. The method for describing the goal of a data mining operation according to claim 4 wherein the database fields have names, the method further comprising comparing the target field name with the result of the lexical analysis.

6. The method for describing the goal of a data mining operation according to claim 4 wherein the database fields have descriptions, the method further comprising comparing the target field description with the result of the lexical analysis.

7. The method for describing the goal of a data mining operation according to claim 4 further comprising:
identifying candidate fields, the candidate fields being relatively more likely to be the dependent variable than other fields in the database;
displaying the candidate fields;
receiving selection input defining the dependent variable based on the candidate fields.

8. The method for describing the goal of a data mining operation according to claim 7, wherein the selection input identifies one candidate field as the dependent variable.

9. The method for describing the goal of a data mining operation according to claim 7, wherein the selection input specifies a formula combining candidate fields to define the true independent variable.

10. The method according to claim 2, wherein the user interface resides on a client system and the text parser resides on a server system.

11. The method according to claim 2 wherein the user interface and the text parser reside on the same system.

12. A method in a computer system for communicating results of a data mining operation, the method comprising:
identifying key performance results;
providing a user interface having a control for communicating information;
communicating a natural language description of the key performance results using the control on the user interface.

13. The method in a computer system for communicating results of a data mining operation according to claim 12 further comprising
providing a robust data model comprising each algorithm used, each algorithm's parameters, each algorithm's performance results, and input/output specification with time tag; and
providing as part of the user interface text templates for communicating the key performance results.

14. The method in a computer system for communicating results of a data mining operation according to claim 13 further comprising
providing as part of the user interface a plurality text templates for communicating the key performance results;
selecting one text template from among the plurality of text templates for communicating the key performance results, whereby the user interface does not display the same text template for every data mining operation.

15. The method according to claim 14 wherein the user interface is provided on a client system and the data model is provide on a server.

16. The method according to claim 14 wherein the user interface and the client system are both contained on a general-purpose computer.

17. A method in a computer system for controlling a data mining operation, the method comprising:
receiving problem specification input determining a data mining operation goal, wherein the input data determining a data mining operation goal is the only input required by the data mining application.

18. The method according to claim 17 wherein the problem specification input is a formal definition based on a data model.

19. The method according to claim 17 wherein the problem specification input is natural language data.

20. The method according to claim 17 or claim 18 further comprising:
identifying key performance results;
providing a user interface having a control for communicating information;
communicating a natural language description of the key performance results using the control on the user interface.

21. A data mining application user interface comprising:
a control that receives natural language input describing the goal of a data mining operation; and
an interface that sends the natural language input to a text parser.

22. The data mining application user interface according to claim 21, wherein the text parser is available to look for keywords, the text parser is available to perform lexical analysis using Bayesian networks, and the text parser is available to calculate maximum a posteriori probabilities for candidate target fields by comparing the results of the lexical analysis with the table-space field names.

23. The data mining application user interface according to claim 22, wherein the input data determining a data mining operation goal is the only input required by the data mining application.

24. A computer data signal stream for communicating the goal of a data mining operation, the data signal stream comprising:
natural language input data describing the goal of the data mining operation, the natural language input data being available for lexical analysis to identify at least one candidate data field;
problem specification data which specifies a goal of the data mining operation based on the at least one candidate data field identified by lexical analysis.

25. A computer data signal stream for controlling a data mining operation, the data signal stream consisting essentially of input data specifying the goal of the data mining operation, whereby no additional input is required to obtain useful results.

26. An article of manufacture for a data mining application, the data mining application being available to perform a data mining operation on a database having fields, the data mining operation based on a dependent variable, the article of manufacture comprising a computer readable medium, the computer readable medium containing:
computer program code that provides for receiving natural language data describing the goal of a data mining operation;
computer program code that provides for sending the natural language data to a text parser;
computer program code that provides for performing a lexical analysis of the natural language data using a Bayesian network;
computer program code that compares results of the lexical analysis to a database field to calculate a maximum a posteriori probability that the database field is the dependent variable;
computer program code that outputs the identity of candidate database fields more likely than other database fields to be the dependent variable; and
computer program code that provides for receiving problem specification data based on the candidate database fields.

27. An article of manufacture for a data mining application, the article of manufacture comprising a computer readable medium containing
a plurality of natural language text templates for communicating the key performance results;
computer program code that selects one text templates from among the plurality of text templates for communicating the key performance results, whereby the user interface does not display the same text template for every data mining operation.

28. An article of manufacture for a data mining application, the article of manufacture comprising a computer readable medium containing computer program code that provides for receiving input determining a data mining operation goal, wherein the input determining a data mining operation goal is the only input required by the data mining application.

29. An article of manufacture for a data mining application, the article of manufacture comprising a computer readable medium containing computer program code selected from the group consisting of: computer program code that receives natural language text providing a data mining operation goal; computer program code that displays key data mining performance results in natural language text; and computer program code that receives input providing a data mining operation goal, wherein the input providing a data mining operation goal is the only input required by the data mining application.

30. A user control method for a data mining application, the user control method comprising:
specifying a goal of data mining in natural language text; and
displaying key data mining performance results in natural language text.

31. The method for providing user control of a data mining application according to claim 29, wherein the specifying a data mining goal is the only user action required, and further comprising an interrupt mechanism to display intermediate results.

32. The control method for providing user control of a data mining application according to claim 29 wherein specifying a goal of data mining in natural language text further comprises:
receiving natural language text describing a data mining problem, wherein a data mining problem includes at least one dependent variable,
performing lexical analysis on the natural language text with a Bayesian network, and
recommending a small number of fields relatively likely to be candidates for the at least one dependent variable of the data mining operation goal.

33. The method for providing user control of a data mining application according to claim 29 wherein specifying a goal of data mining in natural language text further comprises:
providing a set of named fields,
receiving natural language text describing a data mining problem, wherein a data mining problem includes at least one dependent variable,
identifying key words in the natural language text,
performing lexical analysis on the natural language text with a Bayesian network,
calculating maximum a posteriori probabilities for fields by comparing lexical analysis results with field names, and
recommending a small number of fields relatively likely to be candidates for the at least one dependent variable of the data mining operation goal,
communicating the fields relatively likely to be candidates to the user,
receiving additional input identifying the dependent variable,
for each target candidate, ranking input features based on their level of contribution to the expected data mining performance.

34. The method for providing user control of a data mining application according to claim 29 wherein displaying key data mining performance results in natural language text

35. A problem specification method for mapping a data mining goal expressed in natural language to data fields, the method comprising:
providing a set of fields having field names,
receiving natural language text describing a data mining operation goal, wherein a data mining operation goal includes at least one dependent variable,
identifying key words in the natural language text,
performing lexical analysis on the natural language text with a Bayesian network,
calculating maximum a posteriori probabilities for fields by comparing lexical analysis results with field names,
recommending a small number of fields relatively likely to be candidates for the at least one dependent variable of the data mining operation goal,
communicating the fields relatively likely to be candidates to the user,
receiving additional user input specifying the dependent variable, and
for each target candidate, ranking input features based on their level of contribution to the expected data mining performance.
